(19) United States
(12) Patent Application Publication
(10) Pub. No.: US 2025/0320922 A1
(43) Pub. Date: Oct. 16, 2025

(54) INTELLIGENT WIND GATE DEVICE WITH DIVERSION STRUCTURE FOR PRESSURE DETECTION

(71) Applicants: WIN-CHIANG STAINLESS STEEL CO., LTD., Taoyuan City 325019 (TW); KINGLAB LABORATORY EQUIPMENT CO., LTD., Taoyuan City 325019 (TW)

(72) Inventors: Jin-Zong Lee, Taoyuan City 325019 (TW); Wen-Shun Lee, Taoyuan City 325019 (TW)

(21) Appl. No.: 18/933,939

(22) Filed: Oct. 31, 2024

(30) Foreign Application Priority Data
Apr. 12, 2024 (TW) 113113715

(51) Int. Cl. F16K 3/03; F24F 7/04; F24F 11/72; F24F 110/40

(52) U.S. Cl. CPC F16K 3/03; F24F 7/04; F24F 11/72; F24F 2110/40

(57) ABSTRACT

The present invention discloses an intelligent wind gate device with diversion structure for pressure detection. It primarily improves upon conventional wind gate device, which cannot automatically control, have interlinked internal blades that are prone to damage and cannot be replaced individually, and whose interlinked blades make it difficult to achieve a tight seal when opening and closing. This invention proposes a wind gate device that ensures stable exhaust when opened, high sealing performance when closed, and features a deflector component for pressure measurement. It can more accurately measure functions such as air pressure, airflow rate, air volume, temperature, humidity, PH levels, and gas concentration within the air duct.

### BACKGROUND OF INVENTION

### (1) Field of the Invention

The present invention relates generally to a wind gate device, and more particularly to an intelligent wind gate device with diversion structure for pressure detection, which features stable air discharge when open, and reliable sealing when closed, and which can automatically and more accurately detect the wind pressure, flow rate, flow capacity, temperature, humidity, acidity or alkalinity, gas concentration etc inside the air duct.

### (2) Description of Related Art

A wind gate is a device installed in a ventilation duct for controlling air flow. In particular, it determines the passage of air flow by opening/closing the valve structure configured. Referring to FIG. 1, a prior art single blade valve wind gate is depicted. As obviously depicted, the inner channel of the wind gate (1) can allow air flow to pass through. The wind gate (1) includes a valve (11), two detectors (12) and a bored plate (13) configured between two detectors (12). Specifically, the valve (11) is used to control the air flow. Two pairs (P1, P2) of detectors (12) form one unit. The two pairs of detectors (12) calculate the pressure difference based on the air flow into the bored plate (13), so as to detect wind pressure, wind speed, air quantity etc. However, the prior art single blade valve wind gate has the following problems to be solved:
1. Space occupation: When the valve is open and tilted to left or right, it occupies a large space.
2. Unstable air flow: As the valve gate is adjusted by tilting toward the left or right and the area of the opening is not proportional to the tilting angle, it is very difficult to control flow capacity. Moreover, the tilted valve gate may cause flow direction turbulence and obstruction to the gas flow when the air flow impacts the wall surface or corner.
3. Insufficient sealing: If the air duct and the valve are tightly fitted, the valve cannot be opened and closed freely, and may be easily broken.

When the valve can open and close easily, the sealing will be affected, resulting in back flow of the discharged exhaust gas.
4. In accurate wind pressure/wind speed measurement: The unstable air flow may cause inaccurate data measured by the detectors configured in the air duct. Moreover, if there are insufficient detectors, the data obtained cannot be stable and consistent. If there are too many detectors, the installations will be difficult, and too much data may cause inaccurate calculations.

To overcome the above problems, PRC Patent No. M332136 disclosed an iris diaphragm type wind gate structure, which is applied on the ventilation duct of a blower. It is configured on the outer side of the inlet of the blower, and includes: a flat cylindrical enclosure, with its front and rear side faces respectively configured with an air inlet and an air outlet at the position of the central axle, thus forming a channel for air passage from the front side to the rear side. Inside the enclosure, an adjusting plate and an iris diaphragm type film blade set are sequentially configured from the air inlet inward, overlapping each other, wherein, the adjusting plate is a ring-shaped plate, and a plurality of long slotted holes in radial directions are arranged in a ring on the adjusting plate, at equal angular intervals. The iris diaphragm blade set is formed by a plurality of (e.g., three or more than three) iris diaphragm type blades of equal shapes arranged in an enclosing manner such that it can be opened and closed in a ring shape. Specifically, each blade is a curved and arched plate body, with its one end being the free end. The top surface of the free end is configured with a convex part to respectively fit into a corresponding long slotted hole on the adjusting plate, and be moved under the drive of the long slotted hole. The other end is the fixed end. The fixed end is configured with an opening to be respectively pinned together and fixed with the opening on the rear side face of the enclosure.

Based on the above structural design, when turning the adjusting plate in the forward or backward direction, the long slotted hole can drive the convex parts on the free ends of the blades of the iris diaphragm blade set to move inward or outward, such that the free ends of the blades move relative inward or outward, thus controlling the size of the opening of the iris diaphragm type wind gate enclosed by the blades. In this way, when the blower is started and air passes through the iris diaphragm type wind gate, the size of the opening of the iris diaphragm type windgate can be controlled to change the air flow capacity. Such an iris diaphragm type wind gate features simple structure, quick operation, convenient installation, and easy control of the air quantity at the inlet of the blower.

However, this structure does not have the function of automatic control, and the blades are designed to be interlinked. Opening and closing is operated only through a long slotted hole together with a shaft rod. Any improper operation may easily cause damage to the whole set of wind gate, and the damaged part cannot be replaced with an individual component (blade). Furthermore, the linked design will limit the diameter of the opening, resulting in oversized diameter of the opening after the wind gate is closed. Therefore, it cannot provide good sealing.

Therefore, how to solve the above problems and shortcomings of the prior art and make improvements has become a research subject for the inventor of the present invention and manufacturers in this field.

### SUMMARY OF THE INVENTION

In view of the aforementioned problems and shortcomings, the inventor of the present invention made great effort in collecting related data and conducting extensive researches, evaluations, trials, and modifications based on his years of experience in this field, and has finally designed the present invention.

The object of the present invention is to provide an intelligent wind gate device with diversion structure for pressure detection, which features stable gas discharge when it is open, and good sealing when it is closed, and which can automatically and more accurately detect wind pressure, flow rate, flow capacity, temperature, humidity, acidity or alkalinity, gas concentration etc. in the air duct.

To accomplish the above object or other goals, the present invention provides an intelligent wind gate device with diversion structure for pressure detection, to be installed on a ventilation duct. The device includes: an air outlet pipe, for discharge of air flow; a gate, connected on one end of the air outlet pipe, including a slotted disk, a tooth disk held on the slotted disk and a plurality of gate blades held on the tooth disk, wherein the slotted disk is configured with a plurality of sliding slots, and the tooth disk is configured with a plurality of locating points, the plurality of gate blades respectively have a locating shaft and a sliding shaft on the two ends, the locating shaft is fixed on the locating point, the sliding shaft is fitted into the sliding slot, the sliding shaft can move inside the sliding slot for the plurality of gate blades to open or close the gate, the gate further includes a diversion structure, configured on a central position of the plurality of gate blades, when closed, the plurality of gate blades can abut the diversion structure, specifically, the diversion structure includes a shutter divertor and a fixing frame, with its inside disposed with a total pressure air outlet connecting pipe, one end of the total pressure air outlet connecting pipe has a total pressure air inlet hole; an air inlet pipe, connected on one end of the gate; an air collecting chamber, configured on any one of the gate, the diversion structure, the air inlet pipe, the air outlet pipe, the air collecting chamber including a differential pressure air inlet hole and a differential pressure air outlet connecting pipe; and a plurality of detectors, configured on the differential pressure air outlet connecting pipe and on the other end of the total pressure air outlet connecting pipe for detection.

In one preferred embodiment, the air collecting chamber is configured on the gate, and the air collecting chamber includes a differential pressure air inlet hole and a differential pressure air outlet connecting pipe.

In one preferred embodiment, the air collecting chamber is configured inside the shutter divertor. The inside of the shutter divertor is disposed with a total pressure air outlet connecting pipe and a differential pressure air outlet connecting pipe. One end of the total pressure air outlet connecting pipe has a total pressure air inlet hole. One end of the differential pressure air outlet connecting pipe is connected to the air collecting chamber, while the other end has a differential pressure air inlet hole.

In one preferred embodiment, the air inlet pipe is connected on one end of the gate, and includes an inner tube and an outer tube configured outside the inner tube, the outer wall surface of the outer tube has an outer ring, the inner tube wall surface corresponding to the top end of the outer ring has at least one differential pressure air inlet hole, the inside of the outer ring is formed with an air collecting chamber, and a differential pressure air outlet connecting pipe is configured outside the chamber.

In one preferred embodiment, the tooth disk further includes a big gear, a small gear and a motor, the big gear is configured on the outer wall surface of the tooth disk, the small gear is configured on the edge of the tooth disk and is engaged with the big gear, and the motor is connected on the small gear to provide a driving force.

In one preferred embodiment, the diversion structure further includes a closed protrusion, positioned on the outer wall surface of the shutter divertor.

In one preferred embodiment, the small gear is connected on a hand wheel.

In one preferred embodiment, the plurality of detectors are wind pressure detector, flow rate detector, flow capacity detector, temperature detector, humidity detector, acidity or alkalinity detector or gas concentration detector.

In one preferred embodiment, the invention further includes a main control system, connected to the plurality of detectors and the motor, to receive data transmitted by the plurality of detectors, to alert exceptional conditions based on the detected data, and to control the motor.

In one preferred embodiment, the gate further includes a gear position detector, connected to the main control system, which can be used to control the motor and detect the rotational positions of the big gear and the small gear.

In one preferred embodiment, the main control system further includes a gate control module and a processing module, wherein the gate control module is configured in the main control system, to receive data transmitted by the plurality of detectors, to alert exceptional conditions based on the detected data, and to control the motor to open or close the gate to a specific angle. Specifically, the processing module receives the data transmitted by the plurality of detectors and constructs a flow capacity feature fitting curve, and, according to the judgement made from the flow capacity feature fitting curve, sends a control signal to the gate control module to control the degree of openness of the gate, thus adjusting the gas flow.

In one preferred embodiment, the invention includes a disaster prevention apparatus, connected to the main control system, to take appropriate actions according to the detected conditions.

### BRIEF DESCRIPTION OF DRAWINGS

FIG. 1. is a schematic view of the prior art single blade valve wind gate;

FIG. 2. is an exploded perspective view of a preferred embodiment of the intelligent wind gate device of the present invention;

FIG. 3. is a schematic implementation view I of a preferred embodiment of the intelligent wind gate device of the present invention;

FIG. 4. is a schematic implementation view Il of a preferred embodiment of the intelligent wind gate device of the present invention;

FIG. 5. is a schematic implementation view III of a preferred embodiment of the intelligent wind gate device of the present invention;

FIG. 6. is a schematic implementation view IV of a preferred embodiment of the intelligent wind gate device of the present invention;

FIG. 7. is a schematic implementation view V of a preferred embodiment of the intelligent wind gate device of the present invention;

FIG. 8. is a schematic implementation view VI of a preferred embodiment of the intelligent wind gate device of the present invention;

FIG. 9. is a schematic implementation view VIII of a preferred embodiment of the intelligent wind gate device of the present invention;

FIG. 10. is a schematic implementation view I of a further preferred embodiment of the intelligent wind gate device of the present invention;

FIG. 11. is a schematic implementation view Il of a further preferred embodiment of the intelligent wind gate device of the present invention;

FIG. 12. is a schematic implementation view III of a further preferred embodiment of the intelligent wind gate device of the present invention;

FIG. 13. is a schematic implementation view IV of a further preferred embodiment of the intelligent wind gate device of the present invention;

FIG. 14. is a schematic implementation view V of a further preferred embodiment of the intelligent wind gate device of the present invention;

FIG. 15. is a schematic implementation view VI of a further preferred embodiment of the intelligent wind gate device of the present invention;

### DETAILED DESCRIPTION OF THE INVENTION

For a more complete understanding of the technical and structural features of the present invention to accomplish the foregoing object and effects, as well as its functions and advantages, reference is now made to the following description, taken in conjunction with the preferred embodiments and the accompanying drawings.

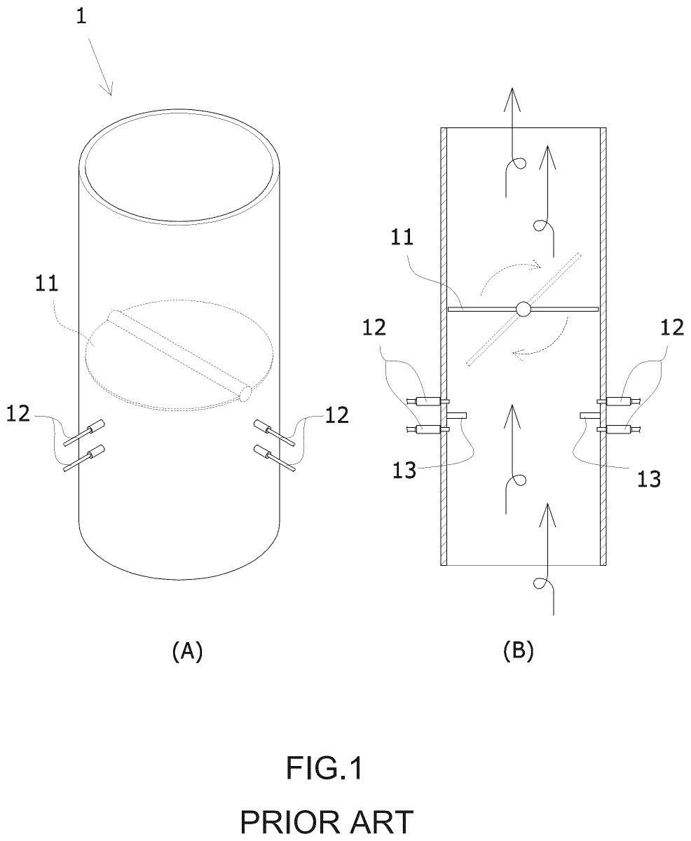

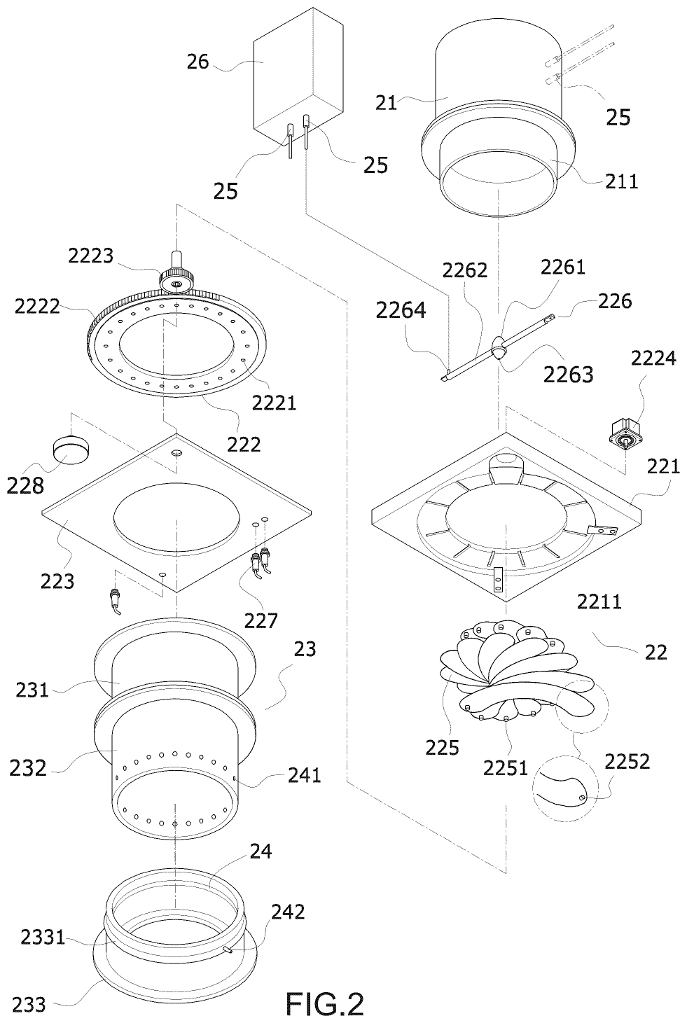

FIGS. 2˜9 are exploded perspective views and implementation views of preferred embodiments of the intelligent wind gate device according to the present invention. As seen from FIG. 1 to FIG. 7, the present invention is an intelligent wind gate device with diversion structure for pressure detection, to be installed on a ventilation duct. More particularly, it can be applied in laboratories and lab hoods, air conditioners in general buildings, range hoods etc. When the wind gate of the present invention is installed in a laboratory or a lab hood, there is a high degree of danger. Apart from the disaster prevention devices already installed in the laboratory/lab hood, if the in-going and out-going gas inside the air duct can be detected, the safety can be better ensured. The wind gate device includes: an air outlet pipe (21), a gate (22) (iris diaphragm valve), an air inlet pipe (23), and a plurality of detectors (25).

The air outlet pipe (21) is used for discharge of air flow, and includes a connecting pipe (211). The gate (22) is connected on one end of the air outlet pipe (21) via the connecting pipe (211).

The gate (22) is connected on one end of the air outlet pipe (21), and includes a slotted disk (221), a tooth disk (222) held on the slotted disk (221) and a plurality of gate blades (225) held on the tooth disk (222). Specifically, the slotted disk (221) is configured with a plurality of sliding slots (2211), the tooth disk (222) is configured with a plurality of locating points (2221), the plurality of gate blades (225) respectively have a locating shaft (2251) and a sliding shaft (2252) on the two ends, the locating shaft (2251) is fixed on the locating point (2221), the sliding shaft (2252) is fitted in the sliding slot (2211), the sliding shaft (2252) can move in the sliding slot (2211) for the plurality of gate blades (225) to open or close the gate (22).

Preferably, the tooth disk (222) further includes a big gear (2222), a small gear (2223), and a motor (2224). The big gear (2222) is configured on the outer wall surface of the tooth disk (222). The small gear (2223) is configured on the edge of the tooth disk (222) and is engaged with the big gear (2222). The motor (2224) is connected on the small gear (2223) to provide a driving force. The small gear (2223) is connected on a hand wheel (228), to facilitate manual control.

The gate (22) further includes an outer cap (223) and a connecting pipe (231). The outer cap (223) is used for connection with one end of the air outlet pipe (21), and the connecting pipe (231) is used for connection with the air inlet pipe (23).

The gate (22) further includes a diversion structure (226), configured on a central position of the plurality of gate blades (225). When closed, the plurality of gate blades (225) can tightly abut the diversion structure (226).

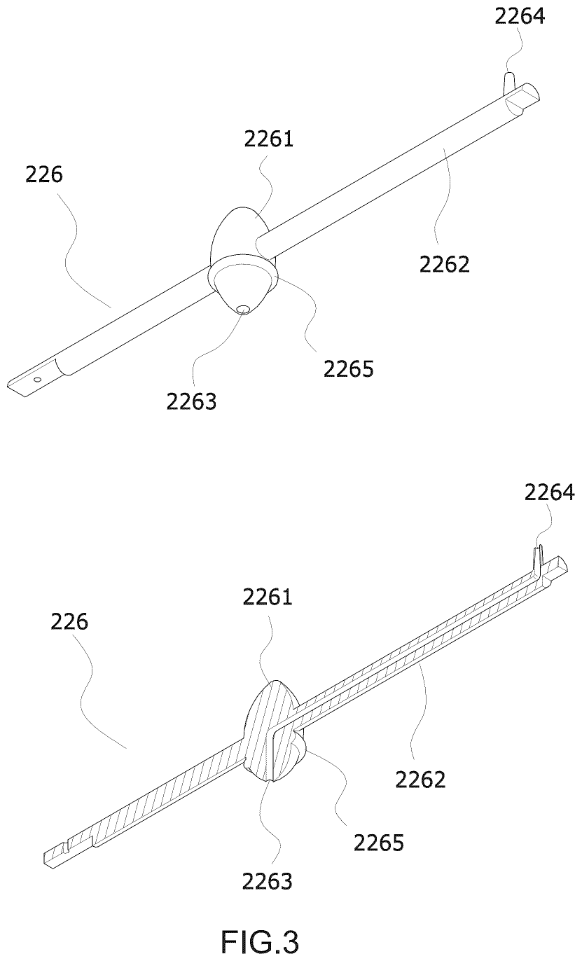

Specifically, as shown in FIG. 3, the diversion structure includes a shutter divertor (2261) and a fixing frame (2262), with its inside disposed with a total pressure air outlet connecting pipe (2264). One end of the total pressure air outlet connecting pipe (2264) has a total pressure air inlet hole (2263). Further, the diversion structure (226) includes a closed protrusion (2265), configured on the outer wall surface of the shutter divertor (2261). It can be used as a second seal when the plurality of gate blades (225) are closed to abut the diversion structure (226), thus doubling the sealing effect.

The gate (22) further includes a gear position detector (227), connected to the main control system (26), which can be used to control the motor (2224) and detect the rotational positions of the big gear (2222) and the small gear (2223).

The air inlet pipe (23) is connected on one end of the gate (22), including an inner tube (232) and an outer tube (233) configured on the inner tube (232). The outer wall surface of the outer tube (233) has an outer ring (2331). The wall surface of the inner tube (232) corresponding to the top end of the outer ring (2331) has at least one differential pressure air inlet hole (241). As can be seen from the drawings, the outer ring (2331) is configured to surround the outer wall surface of the outer tube (233), and the wall surface of the inner tube (232) corresponding to the top end of the outer ring (2331) is configured with multiple differential pressure air inlet holes (241). The inside of the outer ring (2331) is formed with an air collecting chamber (24), and a differential pressure air outlet connecting pipe is configured outside the chamber (242).

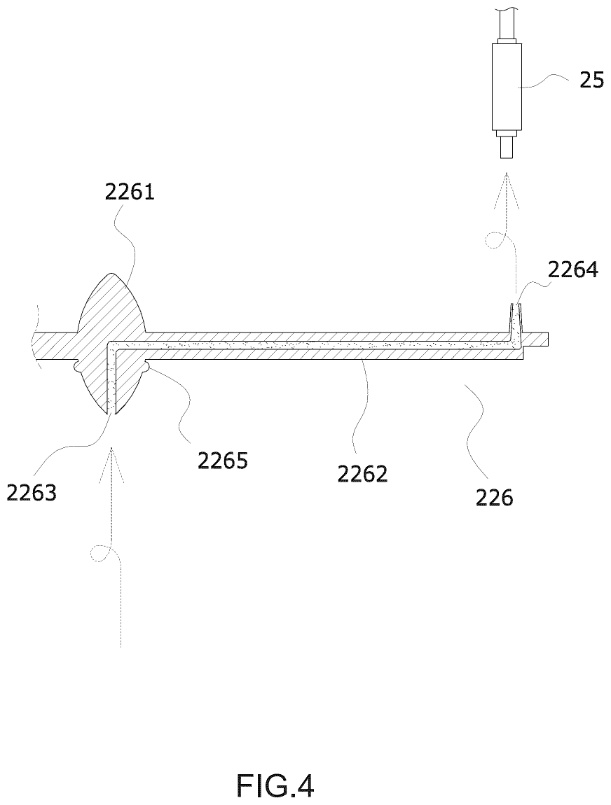

Referring to FIG. 4, the plurality of detectors (25) are configured on the differential pressure air outlet connecting pipe (242) and on the other end of the total pressure air outlet connecting pipe (2264) for detection.

Preferably, the plurality of detectors (25) are further configured on the wall surface of the air outlet pipe (21), extending into the air outlet pipe (21), to detect the gas flow inside the air outlet pipe (21).

The plurality of detectors (25) include but are not limited to wind pressure detector, flow rate detector, flow capacity detector, temperature detector, humidity detector, acidity or alkalinity detector or gas concentration detector.

The intelligent wind gate device of the present invention further includes a disaster prevention apparatus (not shown in the figure), connected to the main control system (26), to take appropriate actions according to the detected conditions.

Based on the above structural design, the use and operation of the present invention are described below: the main control system (26) is connected to the plurality of detectors (25), and the main control system (26) can receive the data transmitted by the plurality of detectors (25). Furthermore, it can process and analyze the data transmitted by the plurality of detectors (25). If any data exceeds the threshold, the main control system (26) can alert an exception. The main control system (26) can also be configured on the cloud, and the plurality of detectors (25) transmit data to the main control system (26) in a wireless manner. The present invention does not limit the means of transmission.

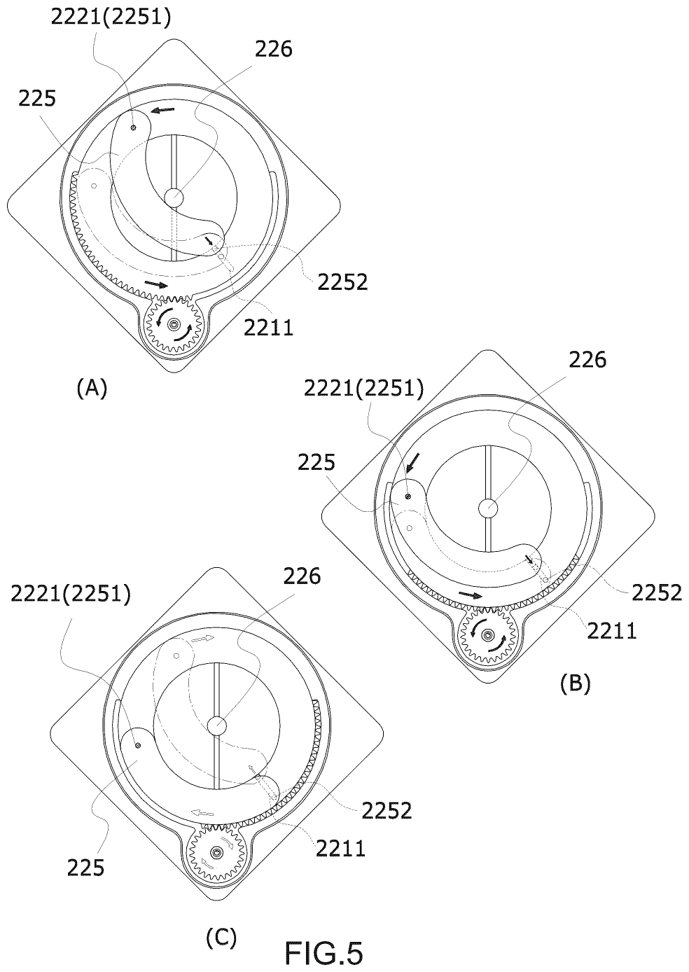

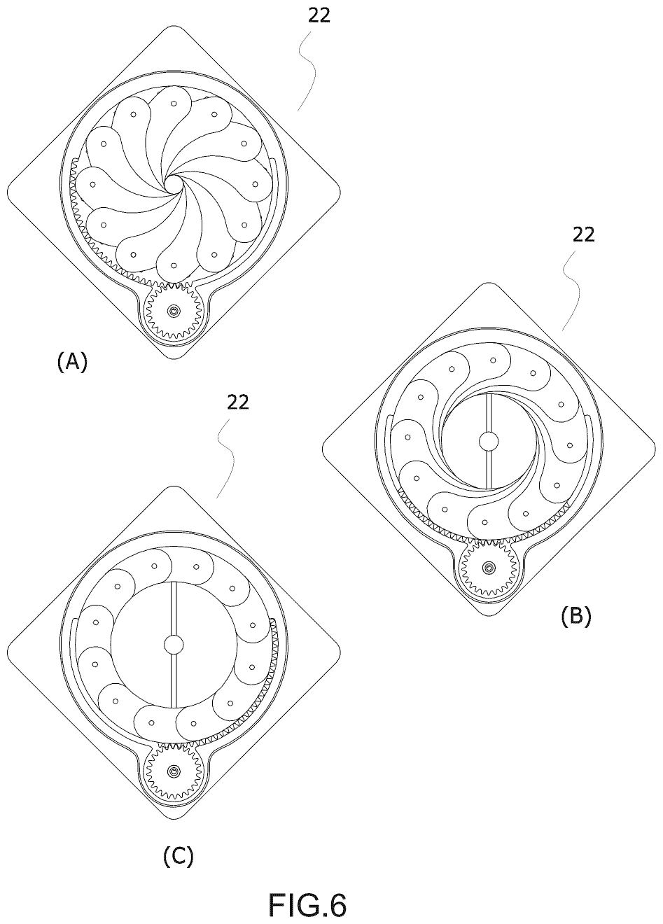

Referring to FIG. 5 and FIG. 6, the gate blade (225) of the present invention operates through movement of individual blades. The two ends of a plurality of gate blades (225) are respectively fixed on the locating points (2221) via the locating shafts (2251). The sliding shaft (2252) is fitted in the sliding slot (2211). The sliding shaft (2252) can move in the sliding slot (2211) for the plurality of gate blades (225) to open or close the gate (22). Because the gate blades (225) are formed by individual blades, if the blades or the axle is damaged, they can be easily replaced with an individual component.

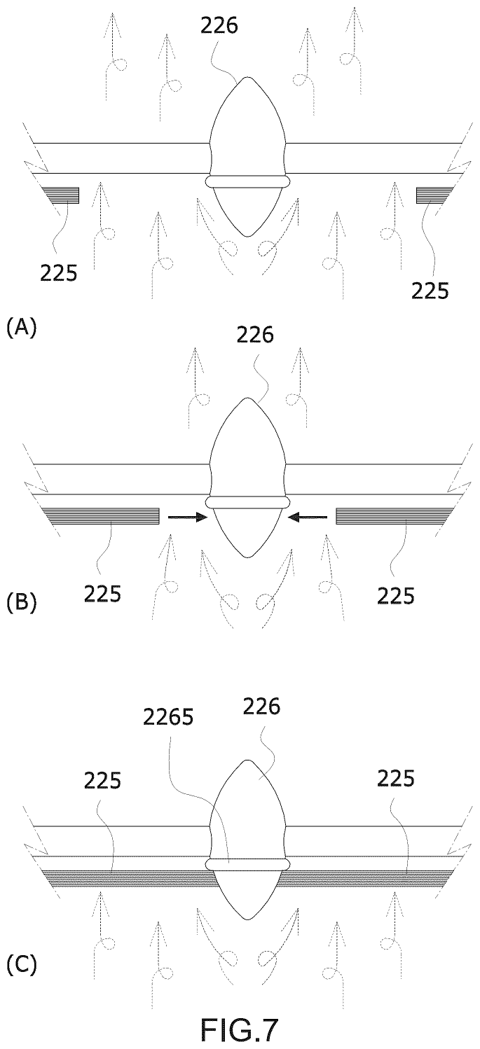

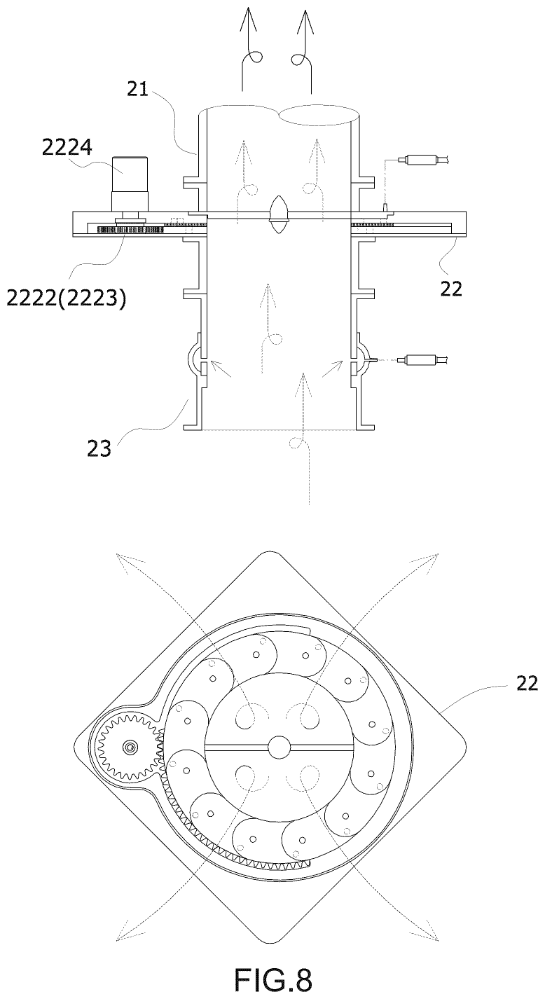

FIGS. 7 and 8 depict a diversion structure (226) of the present invention. The diversion structure (226) is configured on a central position of the plurality of gate blades (225), and includes a shutter divertor (2261). Due to the advantageous streamlined shape of the shutter with a small arc, when a plurality of gate blades (225) are closed, they can abut the diversion structure (226) tightly. This design can also accomplish the function of a fairing to guide the air to flow smoothly in one direction. In terms of the above effects, the “shutter” divertor performs better than the conventional “ball” divertor.

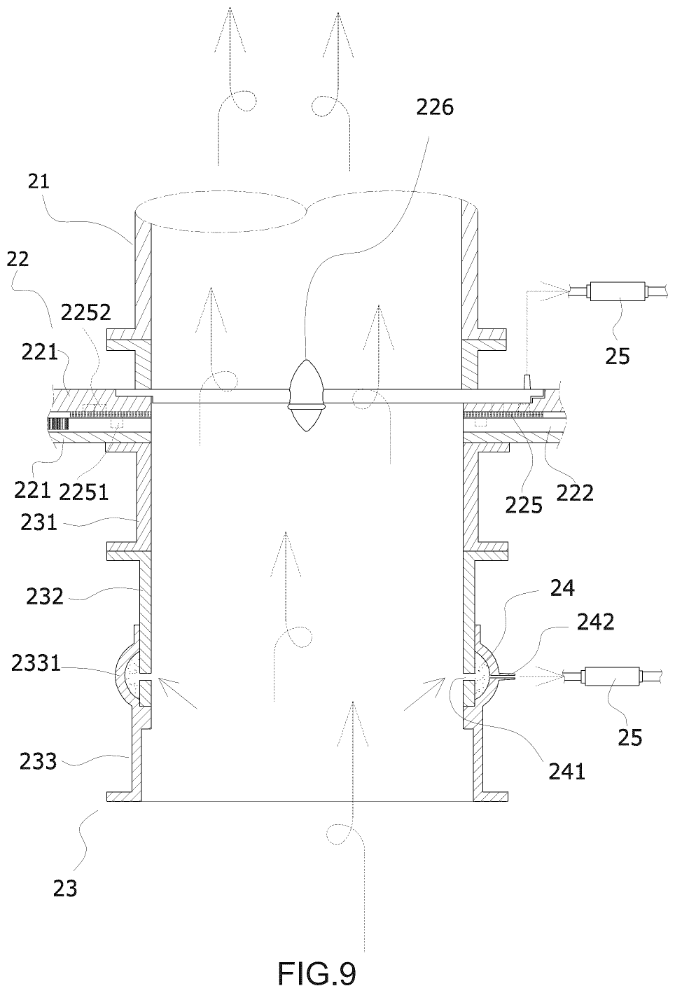

Referring to FIG. 9, the air inlet pipe (23) of the present invention is different than the conventional wind gate by adopting single group detection. When all the discharged gas enters the air inlet pipe, it firstly flows into the air collecting chamber (24) in the differential pressure air inlet hole (241) configured on the outer ring (2331). The detectors (25) detect the data such as the wind pressure, and return the data to the main control system (26). Then, the gas will enter from the total pressure air inlet hole (2263), after flowing through the total pressure air outlet connecting pipe (2264), the detectors (25) will measure data such as the wind pressure, and return the data to the main control system (26). With such a design, the present invention can have better accuracy in measurement.

Preferably, the main control system (26) further includes a gate control module (not shown in the figure) and a processing module (not shown in the figure), wherein the gate control module is configured in the main control system (26), to receive the data transmitted by the plurality of detectors (25), to alert exceptional conditions based on the detected data, and to control the motor (2224) to adjust the degree of openness of the gate. Specifically, the processing module receives the data transmitted by the plurality of detectors (25) and constructs a flow capacity feature fitting curve, and, according to the judgement made from the flow capacity feature fitting curve, sends a control signal to the gate control module to control the degree of openness of the gate (22), thus adjusting the gas flow of the ventilation duct.

Further, for the data transmitted by the plurality of detectors (25), the processing module uses data fitting algorithms such as least square method, conjugate gradient method, or regression analysis method to construct the numerical model of a flow capacity feature fitting curve. When a user presets a flow capacity, using the flow capacity feature fitting curve, the main control system (26) will send a corresponding control signal to the gate control module to control the degree of openness of the gate (22), thus adjusting the gas flow in the ventilation duct. Moreover, based on the feedback information sent by a plurality of detectors (25), the degree of openness of the gate (22) can be further adjusted to provide stable flow capacity and meet the requirement of the preset flow capacity, thus accomplishing the purpose of feedback control.

Further, the present invention includes a main control system (26), connected to the plurality of detectors (25), the motor (2224), and the gear position detector (227), to receive the data transmitted by the plurality of detectors (25), to alert exceptional conditions based on the detected data, and to control the motor (2224) to open or close the gate blades (225). By way of example, the main control system (26) can realize automatic gate (22) opening or closing, automatic alarming, and automatic start of the disaster prevention monitor upon alerts for exception. Through disaster prevention apparatuses such as automatic cooling equipment and fire extinguishing equipment using water, foam, mist, carbon dioxide, dry powder etc., disasters can be avoided.

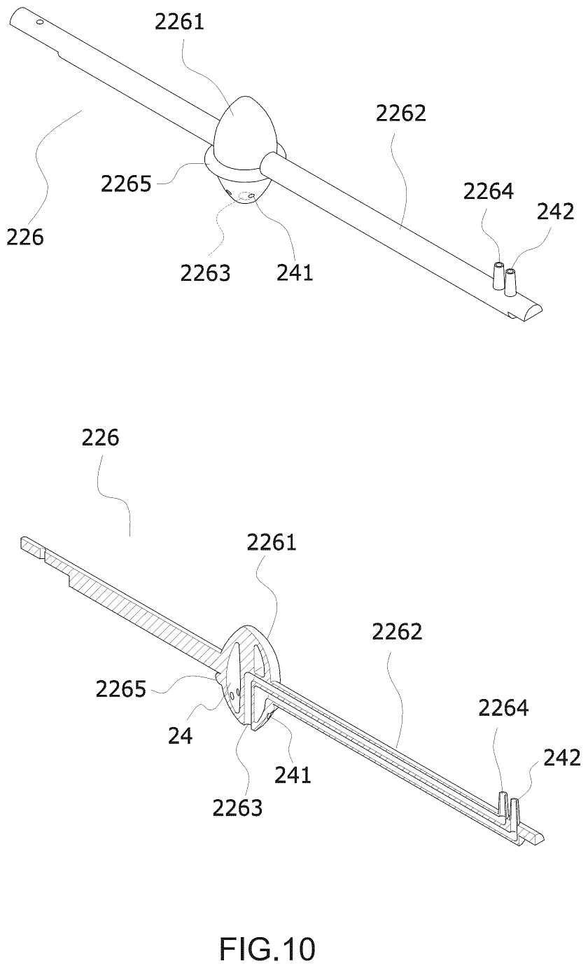

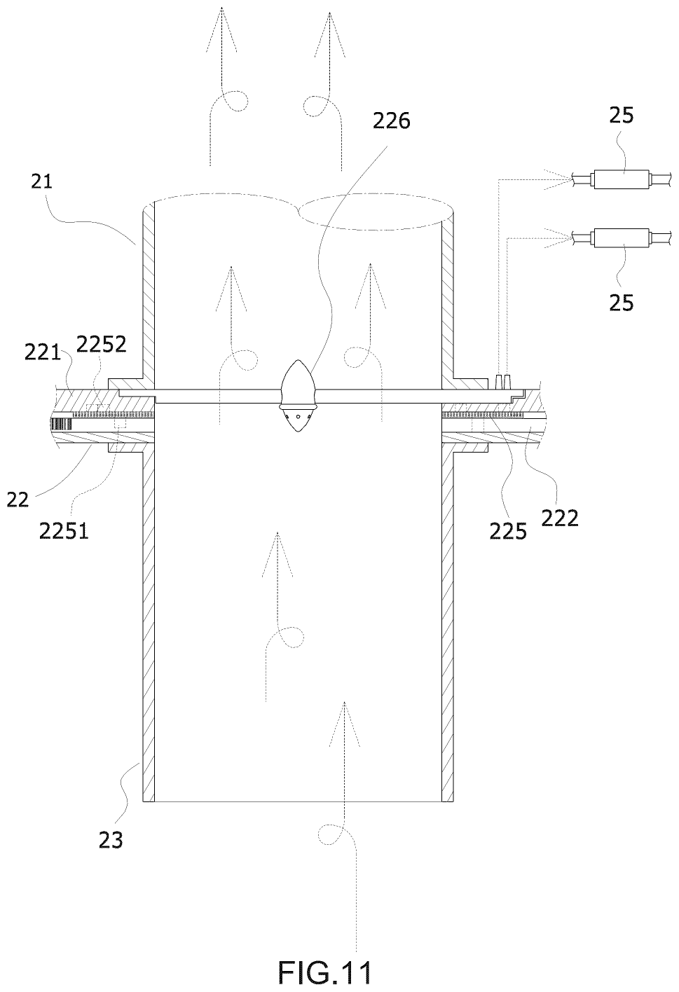

FIGS. 10-12 depict a further preferred embodiment of the intelligent wind gate device with diversion structure for pressure detection according to the present invention. This paragraph of description only focuses on the difference from the foregoing embodiments. Specifically, the diversion structure includes a shutter divertor (2261) and a fixing frame (2262), with its inside disposed with a total pressure air outlet connecting pipe (2264) and a differential pressure air outlet connecting pipe (242), one end of the total pressure air outlet connecting pipe (2264) has a total pressure air inlet hole (2263), one end of the differential pressure air outlet connecting pipe (242) is connected with an air collecting chamber (24), and one end of the air collecting chamber (24) has a differential pressure air inlet hole (241).

The plurality of detectors (25) are configured on the differential pressure air outlet connecting pipe (242) and the other end of the total pressure air outlet connecting pipe (2264). This design can omit the configuration of an outer ring (2331) and an air collecting chamber (24) as in the foregoing embodiment.

It is noted that, the air collecting chamber (24) of the present invention can be configured on any of the gate (22), the diversion structure (226), the air inlet pipe (23), the air outlet pipe (21), and the air collecting chamber (24) includes a differential pressure air inlet hole (241) and a differential pressure air outlet connecting pipe (242), the plurality of detectors (25) are configured on the differential pressure air outlet connecting pipe (242) and on the other end of the total pressure air outlet connecting pipe (2264) for detection. By configuring the air collecting chamber (24) flexibly at different positions, the pressure different at any position can be detected as needed to realize flexible and accurate control.

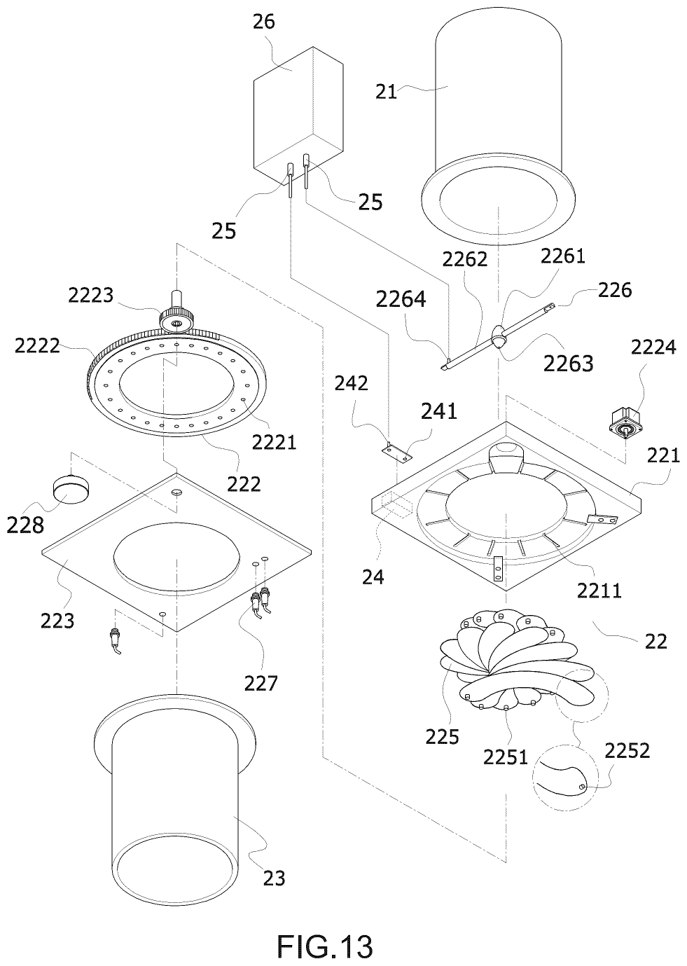

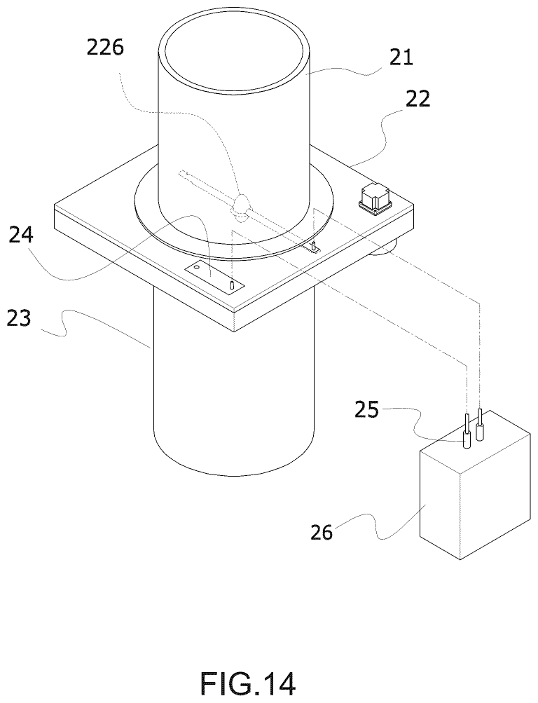

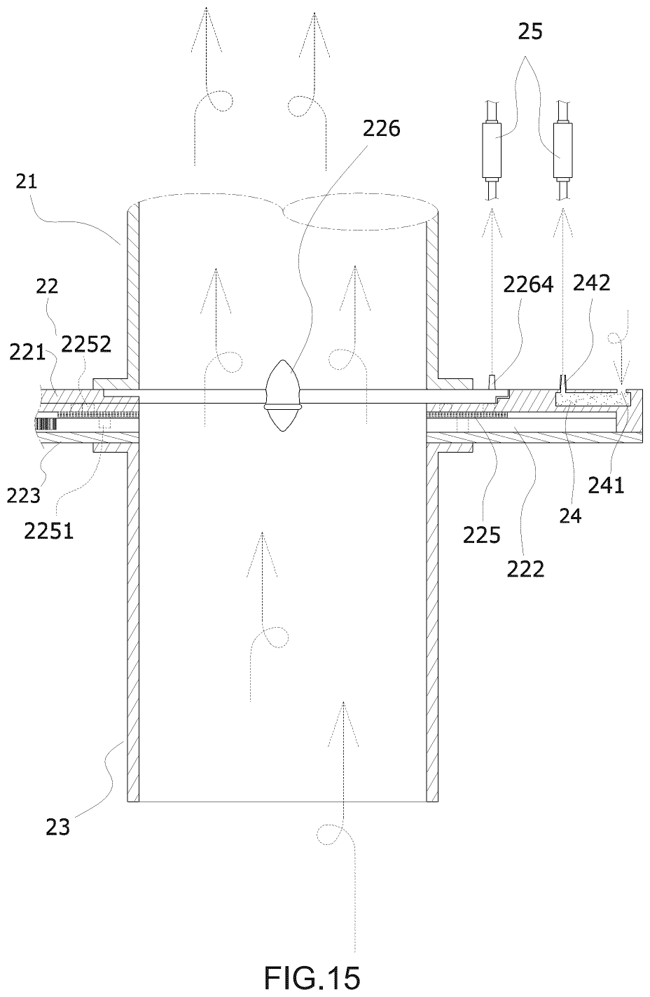

In one preferred embodiment, as shown in FIGS. 13-15, the air collecting chamber (24) can be configured at an appropriate position on the gate (22), for instance, the upper right position shown in FIG. 15. The air collecting chamber (24) includes a differential pressure air inlet hole (241) and differential pressure air outlet connecting pipe (242). When the air flow enters from the differential pressure air inlet hole (241) and flows out via the differential pressure air outlet connecting pipe (242), it can be detected by the detectors (25).

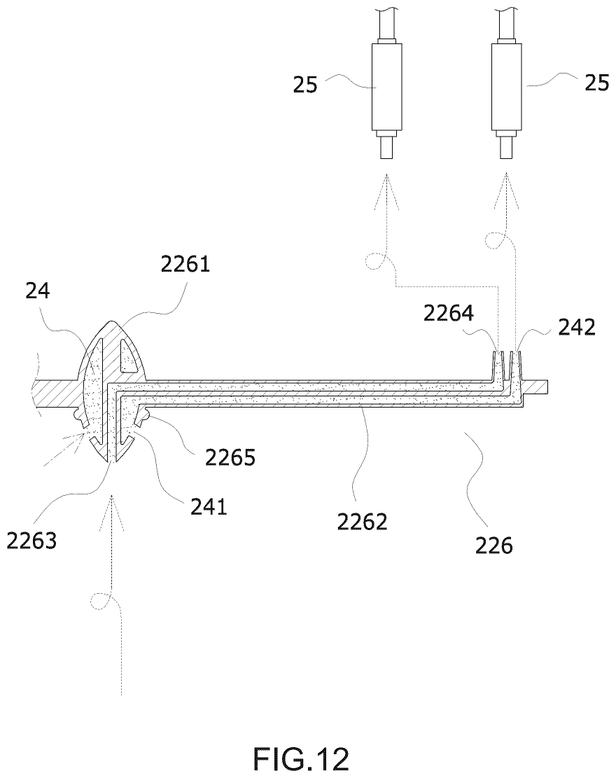

In one preferred embodiment, as shown in FIG. 12, the air collecting chamber (24) is configured inside the shutter divertor (2261), the shutter divertor (2261) has its inside disposed with a total pressure air outlet connecting pipe (2264) and a differential pressure air outlet connecting pipe (242), one end of the total pressure air outlet connecting pipe (2264) has a total pressure air inlet hole (2263), one end of the differential pressure air outlet connecting pipe (242) is connected to the air collecting chamber (24), and the other end has a differential pressure air inlet hole (241).

In one preferred embodiment, as shown in FIG. 9, the air inlet pipe (23) is connected on one end of the gate (22), and includes an inner tube (232) and an outer tube (233) configured outside the inner tube, the outer wall surface of the outer tube (233) has an outer ring (2331), the wall surface of the inner tube (232) corresponding to the top end of the outer ring (2331) has at least one differential pressure air inlet hole (241), the inside of the outer ring (2331) is formed with an air collecting chamber (24), and a differential pressure air outlet connecting pipe is configured outside the chamber (242).

Hence, referring to all the drawings, when the present invention is in use, it truly has the following advantages in comparison to the prior art: when the intelligent wind gate device with diversion structure for pressure detection of the present invention is open, the air discharge is stable, whereas when it is closed, it has good sealing. Moreover, it can automatically and more accurately detect wind pressure, flow rate, flow capacity, temperature, humidity, acidity or alkalinity, gas concentration etc. in the air duct.

Although the invention has been explained in relation to its preferred embodiment, it is to be understood that many other possible modifications and variations can be made without departing from the spirit and scope of the invention as hereinafter claimed.

What is claimed is:

1. An intelligent wind gate device with diversion structure for pressure detection, to be installed on a ventilation duct, comprising:
an air outlet pipe, for discharge of air flow;
a gate, connected on one end of the air outlet pipe, including a slotted disk, a tooth disk held on the slotted disk, and a plurality of gate blades held on the tooth disk, wherein the slotted disk is configured with a plurality of sliding slots, the tooth disk is configured with a plurality of locating points, the plurality of gate blades respectively have a locating shaft and a sliding shaft on the two ends, the locating shaft is fixed on the locating point, the sliding shaft is fitted into the sliding slot, the sliding shaft can move inside the sliding slot for the plurality of gate blades to open or close the gate, the gate further includes a diversion structure, configured on a central position of the plurality of gate blades, when closed, the plurality of gate blades can abut the diversion structure, specifically, the diversion structure includes a shutter divertor and a fixing frame, with its inside disposed with a total pressure air outlet connecting pipe, one end of the total pressure air outlet connecting pipe has a total pressure air inlet hole;
an air inlet pipe, connected on one end of the gate;
an air collecting chamber, configured on any one of the gate, the diversion structure, the air inlet pipe, or the air outlet pipe, the air collecting chamber including a differential pressure air inlet hole and a differential pressure air outlet connecting pipe; and
a plurality of detectors, configured on the differential pressure air outlet connecting pipe and on the other end of the total pressure air outlet connecting pipe for detection.

2. The intelligent wind gate device with diversion structure for pressure detection defined in claim 1, wherein the air collecting chamber is configured on the gate, and the air collecting chamber includes a differential pressure air inlet hole and a differential pressure air outlet connecting pipe.

3. The intelligent wind gate device with diversion structure for pressure detection defined in claim 1, wherein the air collecting chamber is configured inside the shutter divertor, and the inside of the shutter divertor is disposed with a total pressure air outlet connecting pipe and a differential pressure air outlet connecting pipe, one end of the total pressure air outlet connecting pipe has a total pressure air inlet hole, one end of the differential pressure air outlet connecting pipe is connected to the air collecting chamber, and the other end has a differential pressure air inlet hole.

4. The intelligent wind gate device with diversion structure for pressure detection defined in claim 1, wherein the air inlet pipe is connected on one end of the gate, including an inner tube and an outer tube configured outside the inner tube, the outer wall surface of the outer tube has an outer ring, the inner tube wall surface corresponding to the top end of the outer ring has at least one differential pressure air inlet hole, the inside of the outer ring is formed with an air collecting chamber, and a differential pressure air outlet connecting pipe is configured outside the chamber.

5. The intelligent wind gate device with diversion structure for pressure detection defined in claim 1, wherein the tooth disk further includes a big gear, a small gear and a motor, the big gear is configured on the outer wall surface of the tooth disk, the small gear is configured on the edge of the tooth disk and is engaged with the big gear, and the motor is connected on the small gear to provide a driving force.

6. The intelligent wind gate device with diversion structure for pressure detection defined in claim 1, wherein the diversion structure further includes a closed protrusion, positioned on the outer wall surface of the shutter divertor.

7. The intelligent wind gate device with diversion structure for pressure detection defined in claim 5, wherein the small gear is connected on a hand wheel.

8. The intelligent wind gate device with diversion structure for pressure detection defined in claim 1, wherein the plurality of detectors are wind pressure detector, flow rate detector, flow capacity detector, temperature detector, humidity detector, acidity or alkalinity detector, or gas concentration detector.

9. The intelligent wind gate device with diversion structure for pressure detection defined in claim 5, which further includes a main control system, connected to the plurality of detectors and the motor, to receive data transmitted by the plurality of detectors, to alert exceptional conditions based on the detected data, and to control the motor.

10. The intelligent wind gate device with diversion structure for pressure detection defined in claim 5, wherein the gate further includes a gear position detector, connected to the main control system, which can be used to control the motor and detect the rotational positions of the big gear and the small gear.

11. The intelligent wind gate device with diversion structure for pressure detection defined in claim 9, wherein the main control system further includes a gate control module and a processing module, the gate control module is configured in the main control system, to receive data transmitted by the plurality of detectors, to alert exceptional conditions based on the detected data, and to control the motor to open or close the gate to a specific angle, specifically, the processing module receives the data transmitted by the plurality of detectors and constructs a flow capacity feature fitting curve, and, according to the judgement made from the flow capacity feature fitting curve, sends a control signal to the gate control module to control the degree of openness of the gate, thus adjusting the gas flow.

12. The intelligent wind gate device with diversion structure for pressure detection defined in claim 9, which further includes a disaster prevention apparatus, connected to the main control system, to take appropriate actions according to the detected conditions.
